(19) United States
(12) Patent Application Publication
(10) Pub. No.: US 2020/0361509 A1
(43) Pub. Date: Nov. 19, 2020

(54) MEANS OF TRANSPORT HAVING AN ENERGY STORE

(71) Applicant: Robert Bosch GmbH, Stuttgart (DE)

(72) Inventors: Pierre Nonnenmacher, Minversheim (FR); Ester Ruprecht, Offenburg (DE)

(21) Appl. No.: 16/767,180

(22) PCT Filed: Sep. 20, 2018
(86) PCT No.: PCT/EP2018/075424

§ 371 Date: May 27, 2020

(30) Foreign Application Priority Data
Nov. 30, 2017 (DE) 10 2017 221 482.1

(51) Int. Cl. B62B 5/00; B62B 9/08; H01M 2/10

(52) U.S. Cl. CPC B62B 5/0036; B62B 5/0053; H01M 2220/20; H01M 2/1094; H01M 2/1077; B62B 9/08

(57) ABSTRACT

The invention relates to a means of transport (10) having at least one wheel (12), which is driven by means of an electric motor (14). The electric motor (14) is part of the means of transport. It furthermore comprises a brake (16) for braking the wheel (12) and/or the motor (14), wherein the brake (16) has an actuating means (18). The motor is supplied by an energy store (20). According to the invention, the energy store (20) is fixed to the actuating means (18).

### BACKGROUND OF THE INVENTION

The present invention relates to a means of transport, which is preferably a baby carriage, driven by an electric motor and with electric energy supplied by an energy store.

Means of transport are known, which have an electric motor which is supplied with electric energy by means of a battery or an accumulator. In this case, such as in DE 10 2011 14337 A1 for example, the accumulator is mounted on the means of transport in such a way that it takes up space which is needed for other components. In the said document, the energy store is attached on the underside of a baby carriage, wherein it is assembled directly below the lying surface of the baby carriage. On the one hand, this hampers the cooling of the energy store and, on the other, it transfers heat into the passenger transportation area of the baby carriage. Moreover such a position of the accumulator is a hindrance when collapsing the baby carriage.

### SUMMARY OF THE INVENTION

The present invention according to the invention has the advantage that an energy store is mounted in an easily accessible and, at the same time, spatially economical manner in the region of an actuating means of a brake of a means of transport. This enables a space-saving configuration, keeping free installation space which is conventionally needed for other components. In this exposed position, the energy store is furthermore easy to cool since there are no surrounding parts of the means of transport acting in a heat-insulating manner on the energy store. Moreover, as a result of the novel position of the energy store, easy handling in terms of replacement and/or recharging is realized since the accessibility is increased considerably compared to the positions of the energy store which are proposed in the prior art. To achieve the advantages, the means of transport comprises at least one wheel, which is driven by means of an electric motor. This wheel with the motor is braked by the brake. In this case, the brake can cooperate either with the wheel or with the motor or even with both to lock the means of transport or to alter its speed. The actuating means is provided to operate the brake. The energy store, as described above, is mounted according to the invention on this actuating means.

Advantageous further developments and improvements of the device are possible as a result of the measures set out in the dependent claims.

The wheel can be advantageously mounted on an axle. In this alternative, the actuating means is attached to the axle, or at least arranged in the region of the axle. A direct mechanical connection between the actuating means and the wheel can thus be established, which enables a simple construction.

The actuating means can advantageously protrude radially from the axle. Accordingly, the axle has an axial direction and a radial direction, wherein the wheel rotates around the axial direction. The radially protruding actuating means facilitates the operability of the brake so that simple handling of the means of transport can be achieved.

A surprising improvement over the prior art is represented by a guide for the energy store, which can be constructed on the actuating means. the guide enables simple positioning of the energy store so that secure attachment of the energy store can be ensured.

The guide is advantageously formed at least as a groove. The groove or the guide can extend along the actuating means. The guide can be formed on a side of the actuating means which faces the surface on which the means of transport moves. Alternatively or additionally, the guide can be arranged laterally on the actuating means. A plurality of attachment options for the energy store is therefore created.

The energy store can advantageously have at least one guide means, which cooperates with the at least one guide of the actuating means. These corresponding elements can be formed, for example, as a tongue-and-groove-like structure. It is also conceivable for the forms to be reversed so that a guide or groove is formed on the energy store. The guide means can be understood to be a protruding structure which engages in the guide. Such a guide means can be formed both on the energy store and on the actuating means. It is also possible that both the energy store and the actuating means have a guide means and a guide. Particularly secure support of the energy store can be ensured as a result of the plurality of options for the design of the guide structure.

An embodiment in which the energy store is protected against external environmental influences can be very useful. Such environmental influences can be water and/or dust and/or shocks and/or electrostatic charges and/or chemical substances. To generate this resistance to environmental influences, the energy store can be arranged in a shell.

An alternative embodiment comprises a compartment which can be formed on the actuating means. The compartment can serve as guide means and/or as an enclosure against environmental influences. It is also conceivable that a guide structure consisting of guide means and a guide according to the above embodiment can be included in addition to the compartment. The compartment is notable in that it can be fully closable. The energy store can be installed in the compartment and the compartment can be closed by means of a cover. The cover can be attached to the actuating means or to the rest of the compartment via a hinge or other connecting means. However, the cover can also be formed to be loose or it can be integrated in the energy store itself. If the cover is integrated in the energy store, installing the energy store in the compartment results in simultaneous closing and preferably sealing against environmental influences. All these alternative embodiments can result in simplified handling of the means of transport.

In an advantageous further development, the actuating means can have a twin design. In this case, the actuating means, which protrudes radially from the axle, can be formed at two radially opposing points of the axle. It protrudes radially at two opposing points. It is thus possible to create a wider option for accommodating the energy store.

The energy store is preferably rechargeable. Lithium accumulators can be used. In this case, the energy store is advantageously realized in a modular structure by accumulator cells.

In a further development of the invention, the actuating means can be formed as a pedal. It therefore has a planar form, wherein the plane of the surface of the actuating means can be aligned parallel to the longitudinal extent of the axle of the wheel. It is also possible to position the direction of the longitudinal extent of the axle in the plane of the actuating means. This facilitates the mounting of the energy store, since a better attachment option is created.

To install the energy store, it is pushed in the guide, from the free radially protruding end of the actuating means along the guide to the axle. Alternatively, the energy store can also come to a stop before this, which means that it does not have to be pushed up to the axle.

If the actuating means has a linear form, then its radial direction of extent is substantially aligned with the radial direction of the axle. It is alternatively conceivable that the actuating means has a kink so that it is formed in two radial directions relative to the radial direction of the axle. It is thus possible to create storage space for the energy store.

The axle can essentially be equipped with two wheels, which can be mounted in the region of the axial ends. This represents a possible alternative to a variant which can simply have one wheel, wherein the brake can then be formed near to the wheel. As described above, the brake can be activated by an actuating means according to the above embodiments.

All of the above embodiments can be used for a baby carriage. Moreover, the embodiments can also be used in further means of transport, such as wheelbarrows, shopping carts, walking frames, luggage carts, dollies and other short-range means of transport.

### BRIEF DESCRIPTION OF THE DRAWINGS

Drawings are illustrated below, which contain the ideas according to the invention, but do not restrict the invention according to claims. The drawings merely represent a specific embodiment of the invention. Moreover, all features in the drawing, provided they are clear, can be isolated separately and combined with further features within the scope of the invention.

The drawings show:

FIG. 1 an inventive means of transport having a brake and an actuating means on which an energy store is mounted,

FIGS. 2A to 2C various inventive actuating means, which are provided with guides for energy stores to be installed,

FIG. 3 an actuating element with a twin design,

FIG. 4 shows an axle with two wheels and an actuating means and a switch,

FIG. 5 shows a plan view of an axle with an actuating means,

FIG. 6 shows a perspective view of an axle with actuating means,

FIG. 7 shows a section through an actuating means.

### DETAILED DESCRIPTION

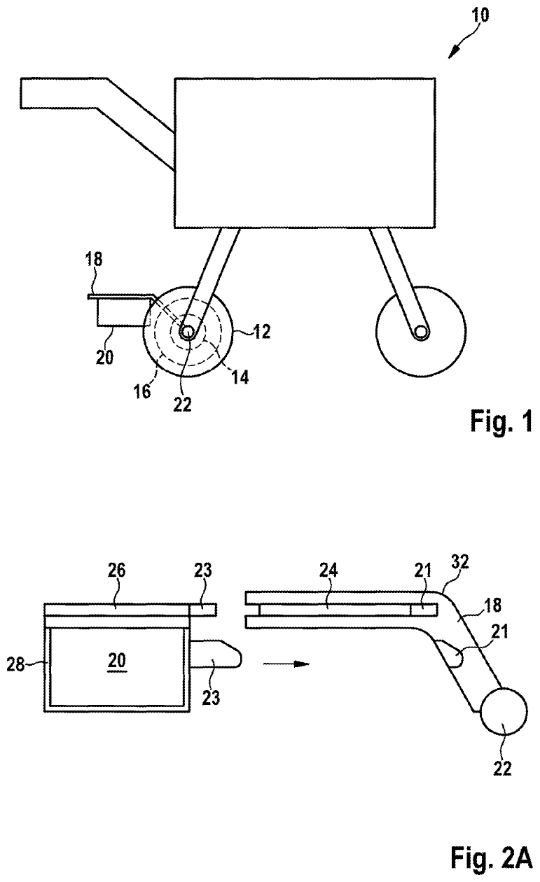

A means of transport 10 is shown in FIG. 1. The means of transport 10 can be a baby carriage, a shopping cart, a walking frame, a dolly, a luggage cart, a scooter, a wheelbarrow or other means of transport. All these means of transport 10 have at least one wheel 12, which is driven by a motor 14. This motor 14 is an electric machine. The wheel 12 can furthermore be locked by a brake 16 or its rotational speed can be altered.

The brake 16 can be actuated by an actuating means 18. In this case, the actuating means 18 extends in the radial direction away from an axle 22 which is located on the axis of rotation of the wheel 12. The actuating means 18 is substantially mounted on the axle 22 and is spaced from the wheel 12 in the axial direction of the axle 22. The actuation of the brake 16 takes place via a mechanical connection of the actuating means 18 and the brake 16.

An energy store 20, which supplies the motor 14 with electric energy, is attached on the underside of the actuating means 18. The underside of the actuating means 18 faces the surface on which the means of transport 10 moves.

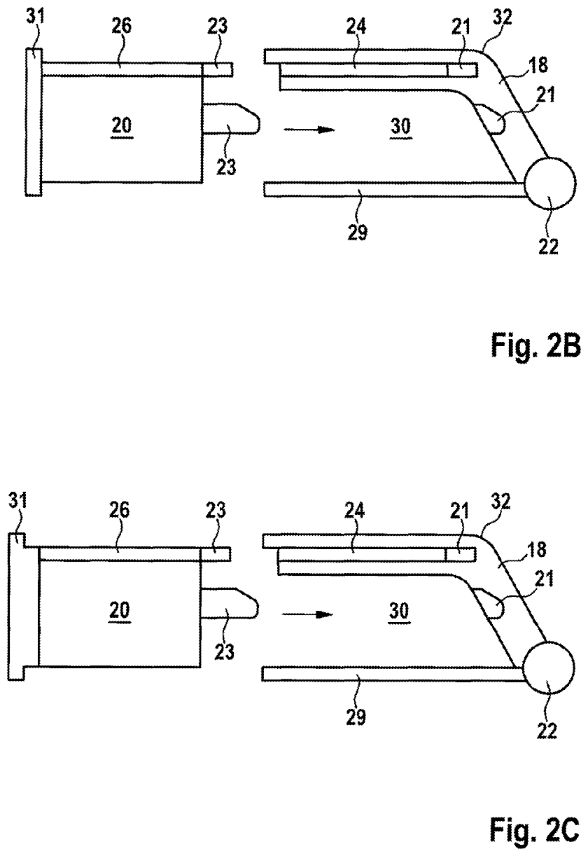

To illustrate the mounting of the energy store 20 on the actuating means 18, FIG. 2 shows a side view of the actuating means 18 and the energy store 20 before the energy store 20 is installed.

A first variant of the construction of the inventive actuating means 18 with the battery 20 is illustrated in FIG. 2 A). The actuating means 18 is attached to the axle 22 of the wheel 12, which is not shown in FIG. 2. The actuating means 18 extends in the radial direction, starting from the axle 22, and has a free end. A guide 24, which extends along the side of the actuating means 18 in its direction of extent, is formed in the region of the free end. The guide 24 is formed in a groove-shape as a slot. Pre-empting FIG. 4, if one now imagines an actuating means 18 which has a planar form, it would be possible to form a respective guide 24 at the edge of the planar actuating means 18 on two opposite sides. One would then achieve a possible embodiment of the device shown in FIG. 2. A guide means 26, which is integrally formed on the energy store 20, can be guided in the guide 24. In this case, the guide means is formed in a complementary manner to the guide 24, which, in the present case, results in a projecting web. The web is guided in the guide 24. To this end, the energy store 20 has a complementary longitudinally extending receptacle, which has two mutually opposing webs. At least one part of the actuating means 18 is installed in the receptacle; in particular, the portion which is arranged below the guides 24. The receptacle has a cross-section which is open to the top in a u shape. The guide means 26 is therefore integrally formed in the upper region of the energy store 20 so that, once installed, the energy store is mounted substantially below the actuating means 18 in a suspended manner.

An alternative embodiment is conceivable, which comprises a planar actuating means 18, which has, on its underside, a receptacle which comprises two mutually facing guides 24 in the region of the lateral edge of the planar actuating means 18. These guides 24 extend at least partially from a free end of the actuating means 18 to a fixed end, which is attached to an axle 22. A cross-section through the actuating means 18 in the direction of the axial direction of the axle 22 in the region of the guides 24 produces a structure which is open to the bottom in a u shape. The guides 24 are formed on the inwardly facing sides of the limbs of the u-shaped structure. The limbs point downwards. The guides can be formed at the same height in the limbs. The energy store 20, with its guide means 26, is configured in a complementary manner to this. The guide means 26 project laterally from the energy store 20 and are formed in a complementary manner to the guide 24. They are preferably formed as a closed, uninterrupted web extending in the installation direction. The guide 24 and the guide means 26 possess a latching function which secures the energy store 20 in the actuating means 18.

Contacts 21 for electrical contacting are integrally formed on the actuating means 18 and associated mating contacts 23 are integrally formed on the energy store 20. The contacts 21 can be integrally formed in the guide 24, for example, and/or on the surface of the actuating means 18 which faces the energy store 20. For example, such a surface can be provided in the region of the axle 22. The mating contact 23 can therefore be integrally formed on the guide means 26 and/or on an end face of the energy store 20 which is facing the axle 22.

The energy store 20 is encapsulated in a shell 28, which protects the energy store 20 from environmental influences. Hermetic sealing of the energy store 20 is thus achieved. Moreover, the shell 28 can also be robustly constructed to withstand mechanical influences. Shielding against electromagnetic influences or chemical influences is likewise possible by means of the shell.

The actuating means 18 has a kink 32, wherein the kink 32 is arranged between the guides 24 and the axle 22. The kink 32 divides the actuating means 18 into a linear portion, which supports the guides 24, and a second portion, which comprises the fixed end of the actuating means 18 with the axle 22. The second portion can be linear or curved. As result of the kink 23, a plane, which contains the linear portion which has the guides 24, is aligned parallel to the longitudinal direction of the axle 22.

According to FIG. 2 B), an energy store 20 can be installed in a compartment 30. The compartment 30 is arranged below the substantially structurally identical actuating means 18. In this case, the compartment 30 comprises a compartment base 29, which extends radially from the axle 22 in the same direction as the actuating means. In this case, the compartment base 29 can be aligned substantially parallel to the linear portion of the actuating means 18 which supports the guides 24.

The energy store 20 is guided into the compartment 30 substantially as in FIG. 2 A) and positioned by means of the guide 24 and the guide means 26. After the installation of the energy store 20 in the compartment 30, a cover 31 is placed on the opening of the compartment 30, which closes the compartment hermetically. It is thus possible to dispense with a shell 28 which surrounds the energy store 20. It can, however, also represent a reinforcement of the shell 20.

The cover 31 can be provided as a loose component, as in FIG. 2 B). Alternatively, it can also be a cover 31 with a hinge, in particular on the free end of the actuating means 18 or on the compartment base 29. Such a cover 31 with a hinge can therefore be folded down onto the opening.

An embodiment with a compartment 30 is likewise shown in FIG. 2 C), wherein, in this case, the cover 31 is attached to the energy store 20. The opening of the compartment 30 is therefore closed automatically with the installation of the energy store 20. The cover 31 is attached to an end of the energy store 20 which is facing contrary to the installation direction. The cover 31 is integrated in the energy store 20.

At the free end, the energy store 20 of FIGS. 2 A), B) and C) is pushed with its guide means 26 into the guide 24 of the actuating means 18 in the direction of the axle 22. In this case, the energy store 20 is guided up to the kink 32 or up to the axle 22 within the guide 24. This takes place until the latching function is actuated. This results in contact between the contacts 21 and the mating contacts 23.

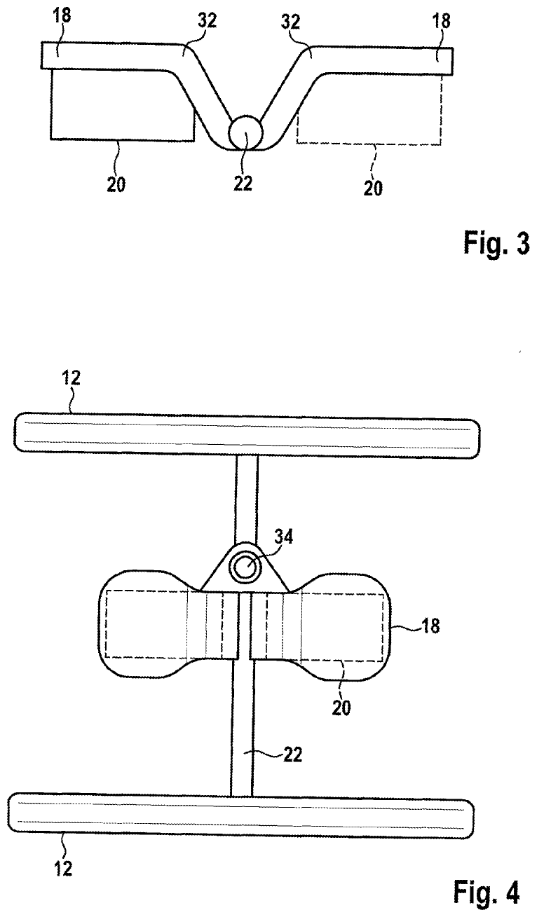

A further embodiment contains two mutually opposing actuating means 18, as shown in FIG. 3. The two actuating means 18 are formed substantially mirror-symmetrically with respect to the axle 22. Both actuating means 18 extend in the radial direction and can likewise have a kink 32. The installation of the energy store 20 can take place as in the embodiments above. Since two actuating means 18 are now provided, two energy stores 20 can be installed. In this case, a respective energy store 20 is mounted on each actuating means 18. It is also possible for only one energy store 20 to be mounted, whilst the second actuating means 18 remains without an energy store 20. The means of transport 10 can therefore be supplied by two energy stores 20 for long distances, for example, and by one energy store 20 for short distances.

A plan view of the axle 22 with two wheels 12 and a twin actuating means 18 is shown in FIG. 4. A switch 34 is formed near to the actuating means 18. The switch 34 can be a button which is actuated by means of a foot of an operator. It can also be a knob for a finger. The switch can be, for example, the main switch for the means of transport 10, with which the means of transport 10 is set to an operating state in which it is ready to start. This configuration according to FIG. 4 is possible for all embodiments which are contained the present description. In particular, this can be combined with a baby carriage.

All embodiments and their features can be combined with one another to provide useful further features within the context of the inventive idea. Therefore, for example, the twin design in FIG. 3 can be combined with the embodiments of FIG. 2.

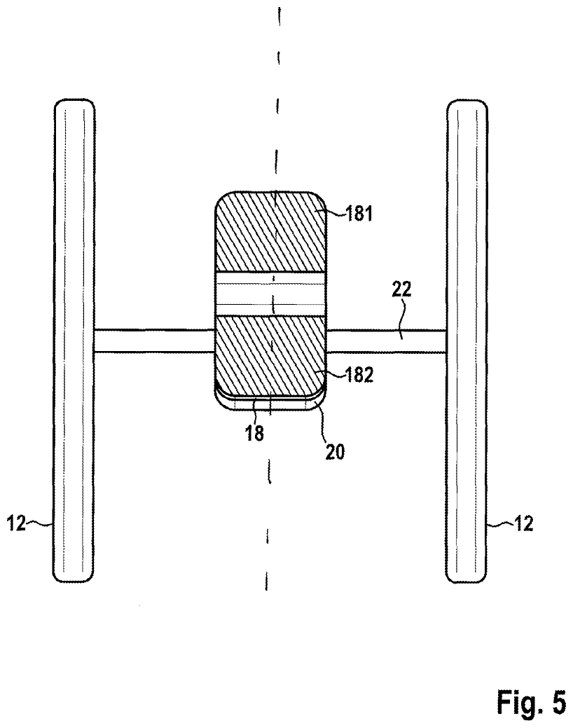

FIG. 5 shows a variant of the invention, in which the actuating means 18 is not arranged symmetrically with respect to the axle 22, so that a relatively large part 181 of the actuating means 18 protrudes radially from the axle 22, whilst a smaller part 182 in relation to the larger part 181 protrudes radially from the axle 22 opposite the larger part 181. The larger part 181 is preferably facing away from a user pushing the means of transport 10 so that the smaller part 182 is facing towards the user.

As shown in the alternative of FIG. 5, the actuating means 18 is arranged centrally between the wheels 12 along the axial direction of the axle 22. This is illustrated by the dashed line, which is merely intended to illustrate the central arrangement.

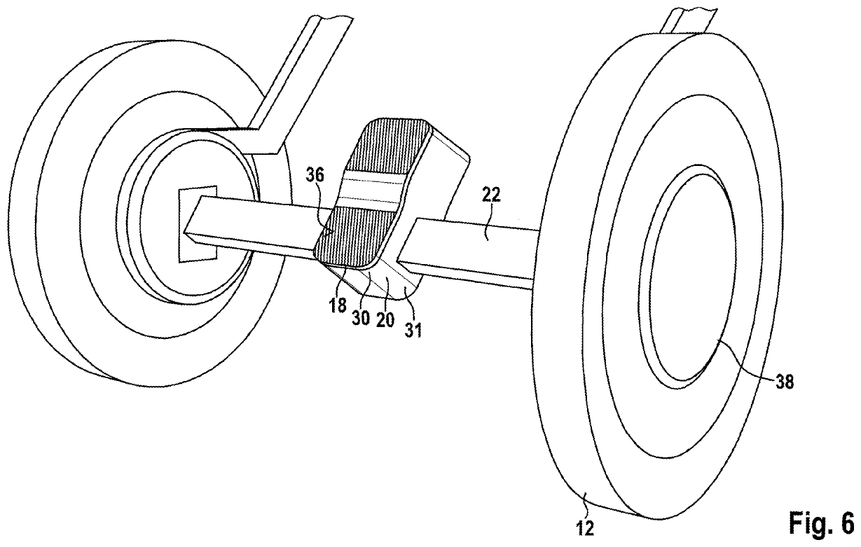

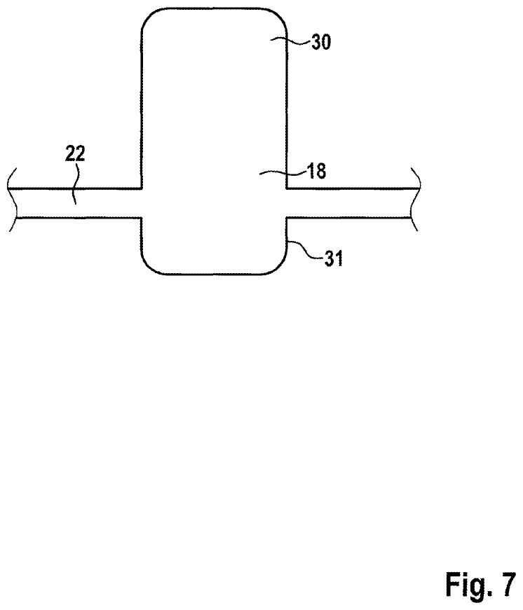

The embodiment of FIG. 6 shows a variant of FIG. 5. The axle 22 can be connected in one piece to a housing 31 for the accumulator 30. This is shown in FIG. 7, in which it can be seen that the axle 22 merges directly into the housing 31 of the receptacle for the accumulator 30. The housing 31 can be constructed as the compartment 30. Therefore, the axle does not extend through the housing 31, which means that the inside space is free of the axle 22. The axle 22 and the housing 31 can be made from the same material.

The axle 22 can have an angular construction as in FIG. 5 or a circular construction, so that torsion properties of the axle 22 or the connection between the axle 22 and the housing 31 can be adjusted.

The brake 16 can be actuated directly by the axle 22. In this case, the axle 22 can rotate as a result of the actuation of the actuating means 18, and actuate the brake 16. It is alternatively conceivable that the axle 22 remains still upon the actuation of the actuating means 18 and the brake 16 is actuated by a mechanism which is arranged within or outside the axle 22.

The actuating means 18 can be coated from above with a non-slip covering 36. In this case, for example as in FIG. 6, the covering 36 can be applied to the housing 31. It is further conceivable that part of the covering 36 is arranged on the accumulator 20. The covering 36 can be made from the material of the housing 31 and simply have a non-slip profile. Alternatively, it can be made from a rubber.

The wheels 12 in FIG. 6 have, at least on an axially facing side, lights 38 which can be circular. The lights can be realized as LED lights. The lights 38 can be arranged in a ring shape around the center of rotation of the wheel 12.

The wheels 12 in FIG. 6 can further comprise wheel hub motors.

1. A transport apparatus (10), comprising:
at least one electric motor (14),
at least one wheel (12) driven by the electric motor (14),
a brake (16) for braking the wheel (12) and/or the motor (14), wherein the brake (16) has an actuating means (18), and
an energy store (20) for the electric motor (14),
wherein the energy store (20) is attached to the actuating means (18).

2. The transport apparatus (10) as claimed in claim 1, characterized in that the actuating means (18) is mounted on an axle (22) of the wheel (12).

3. The transport apparatus (10) as claimed in claim 2, characterized in that the actuating means (18) protrudes radially from the axle (22).

4. The transport apparatus (10) as claimed in claim 1, characterized in that the actuating means (18) comprises a guide (24) which is configured to position the energy store (20).

5. The transport apparatus (10) as claimed in claim 4, characterized in that the guide (24) is at least one groove.

6. The transport apparatus (10) as claimed in claim 4, characterized in that the energy store (20) has a guide means (26) which corresponds to the guide (24).

7. The transport apparatus (10) as claimed in claim 1, characterized in that the energy store (20) is resistant to external environmental influences such as water and/or dust and/or shocks and/or electrostatic charge as a result of being arranged in a shell (28).

8. The transport apparatus (10) as claimed in claim 1, characterized in that a compartment (30) is formed on the actuating means (18) and receives the energy store (20) in order to guide the energy store and/or separate the energy store from the environment.

9. The transport apparatus (10) as claimed in claim 2, characterized in that the actuating means (18) has a twin design and protrudes radially from the axle (22) at two points.

10. The transport apparatus (10) as claimed in claim 1, characterized in that the energy store (20) is rechargeable.

11. The transport apparatus (10) as claimed in claim 2, characterized in that the actuating means (18) has a planar form and a plane of the actuating means (18) is aligned parallel to a longitudinal extent of the axle (22).

12. The transport apparatus (10) as claimed in claim 2, characterized in that the energy store (20) is pushed in the guide (24) from the free radially protruding end of the actuating means to the axle (22).

13. The transport apparatus (10) as claimed in claim 2, characterized in that the actuating means (18) has a kink (32) so that the actuating means extends in two directions relative to a radial direction of the axle (22).

14. The transport apparatus (10) as claimed in claim 2, characterized in that two wheels are mounted on the axle (22).

15. The transport apparatus (10) as claimed in claim 1, characterized in that the transport apparatus is a baby carriage.

16. The transport apparatus (10) as claimed in claim 4, characterized in that the guide (24) is at least one groove, which is arranged on an underside of the actuating means (18) and/or laterally on the actuating means (18).

17. The transport apparatus (10) as claimed in claim 2, characterized in that the actuating means (18) has a twin design and protrudes radially from the axle (22) at two opposing points.

18. The transport apparatus (10) as claimed in claim 1, characterized in that the energy store (20) is rechargeable and comprises accumulator cells.
